(19) United States
(12) Patent Application Publication
(10) Pub. No.: US 2006/0045042 A1
(43) Pub. Date: Mar. 2, 2006

(54) System and method for presence in wireless networks

(76) Inventors: Aseem Sethi, Bangalore (IN); Naresh Sunkara, Bangalore (IN)

Correspondence Address: BAKER & BOTTS, 30 ROCKEFELLER PLAZA, NEW YORK, NY, 10112, US

(21) Appl. No.: 10/930,116

(22) Filed: Aug. 31, 2004

(51) Int. Cl. H04Q 7/00

(52) U.S. Cl. 370/328

(57) ABSTRACT

The invention relates generally to a method for providing presence and instant messaging in a computer network. In particular, the invention is directed to a modified implementation of known wireless networking protocols to provide instant messaging and presence services to mobile units using. The instant messaging and presence services are provided within the framework of the native wireless networking protocol.

### FIELD OF THE INVENTION

The invention relates generally to instant messaging and presence protocols implemented in conjunction with computer networks.

### BACKGROUND OF THE INVENTION

Instant messaging and presence systems allow users to subscribe to each other and be notified of changes in state, and for other users to transmit short instant messages. A model for instant messaging and presence protocols (“IMPP”) has been set forth by Day et al., “A Model for Presence and Instant Messaging,” Network Working Group RFC 2778, February 2000 (hereinafter “RFC 2778”), and Day et al., “Instant Messaging/Presence Protocol Requirements,” Network Working Group RFC 2779, February 2000 (hereinafter “RFC 2779”) (both of which are available on the Internet Engineering Task Force Website at http://www.ietf.org/rfc.html).

Such IMPP services have been successfully implemented in numerous popular network communication and internet communication applications, such as instant messaging applications. Popular examples of Internet-based instant messaging applications include America Online's “AOL Instant Messenger”, Yahoo, Inc.'s “Yahoo Messenger,” and Microsoft Corp.'s “MSN Messenger.”

Service Location Protocol (“SLP”) is another network protocol which presents a flexible and scaleable framework for providing information about the existence, location and configuration of network devices and services. SLP is generally implemented in a local area network to provide a client, e.g., a laptop computer, with information about the types of network services that are available (e.g., local printer devices, applications, etc.). Such a protocol alleviates the need for static configuration of network hosts, and instead provides for a more flexible network configuration.

The need for SLP has increased with the growth of wireless networks. Mobile clients roaming a network may associate with different access points as the client moves, and may come into—and out of—close proximity of services and devices such as printers and fax machines. Moreover, wireless public networks such as “hot spots” have become increasingly popular in public places. First-time users of such networks may otherwise be unaware of the types of services that may be available. Accordingly, it would be advantageous to notify a client of the different services that are available as the client traverses a wireless network.

Prior art implementations of IMPP and SLP generally require separate applications or software operating in a higher layer from the particular network protocol itself. This can be problematic in networks where speed or bandwidth restrictions may result in decreased network performance—as may be the case, for example, in certain wireless local area networks (“WLANs”). The operation of additional software also requires additional processing power for network devices. Furthermore, the increased processing required in such a system can result in greater power consumption, which may be a critical shortcoming in battery-powered mobile devices.

Accordingly, it would be advantageous to provide IMPP and SLP functions natively within a network protocol.

### SUMMARY OF THE INVENTION

In a first exemplary embodiment of the present invention, a method is provided for presence services in a computer network operating according to a network protocol, including the steps of generating a first data packet in a format in accordance with the network protocol, generating a second data packet by inserting presence data into the first data packet, the presence data including at least information relating to one or more services available over the computer network, and transmitting the second data packet over the computer network.

A next exemplary embodiment of a method according to the present invention provides instant messaging services in a network protocol, and includes the steps of generating a first data packet in accordance with the network protocol, generating a second data packet by inserting instant messaging data into the first data packet, the instant messaging data including at least text message data, and transmitting the second data packet over the computer network.

In yet another exemplary embodiment of the present invention, a system for providing IMPP over a computer network is provided. The system includes a computer-readable memory, and a processor coupled to the memory and operable to generate a data packet formatted for transmission in accordance with a network protocol, wherein the processor is further operable to include IMPP data in the data packet before the data packet is transmitted over a computer network.

### BRIEF DESCRIPTION OF THE DRAWINGS

The invention will be further understood from the following detailed description of a preferred embodiment taken in conjunction with an appended drawing, in which:

FIG. 1 is a system diagram for a wireless local area network which may be used in conjunction with an embodiment of the present invention;

FIG. 2 is an illustration of a standard 802.11 management frame;

FIG. 3 is an illustration of a 802.11 management frame modified for use in conjunction with the present invention;

FIG. 4 is an illustration of a 802.11 management frame modified for use in conjunction with the present invention.

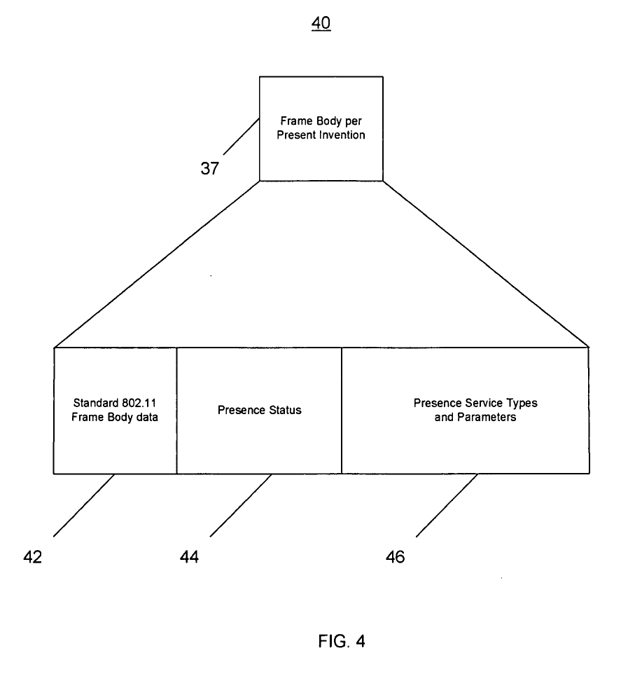

Throughout the figures, unless otherwise stated, the same reference numerals and characters are used to denote like features, elements, components, or portions of the illustrated embodiments.

### DETAILED DESCRIPTION OF THE INVENTION

In one embodiment of a system and method according to the present invention, presence services may be provided in an IEEE 802.11 wireless local area network. The Specification for the IEEE 802.11 protocol, “IEEE 802.11 Standard for Wireless LAN Medium Access Control (MAC) and Physical Layer (PHY) Specifications,” 1999 edition, is fully incorporated herein by reference.

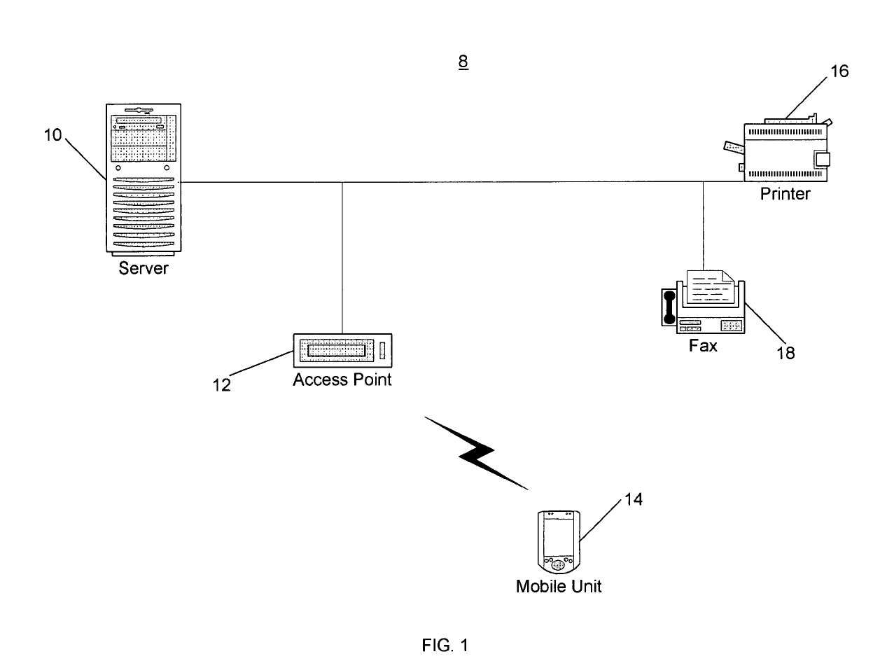

Referring now to FIG. 1, an exemplary 802.11 wireless local area network (“LAN”) 8 is shown. The network 8 may include a server computer 10 and one or more access points 12, which provide wireless access to the LAN. Note that where the present invention is implemented in a wireless LAN, the LAN need not be entirely wireless—it may be part wired as well (as is the case in network 8). Network 8 may also be coupled to one or more printers 16, fax devices 18, or other network devices. One or more mobile units 14 may access the network 8 wirelessly. Mobile unit 8 may be a handheld computer, laptop computer, cellular device, or any other computing device capable of communications with the wireless network 8.

The IEEE 802.11 specification sets forth detailed guidelines for the network communications protocol. In addition to data frames that carry information from higher layers such as the application layer, the 802.11 protocol includes management and control frames that ensure proper network operation. Three types of management frames include beacon frames, probe request frames, and probe response frames.

As described in the 802.11 specification, the beacon frame enables wireless devices to establish and maintain communications in an orderly fashion. An access point periodically sends a beacon frame to announce its presence and relay information, such as timestamp, SSID, and other parameters regarding the access point to mobile units that are within range. Mobile units continually scan all 802.11 radio channels and listen to beacons as the basis for choosing which access point is best to associate with.

A station may send a Probe Request frame, another type of management frame, to obtain information about another station. For example, a mobile unit may transmit a probe request to determine which access points are within range. In response to a Probe Request, an access point or mobile unit may respond with a Probe Response frame, which contains capability information, supported data rates, and other vital network information. Beacons, Probe Requests, and Probe Responses are critical to the proper operation of an 802.11 WLAN.

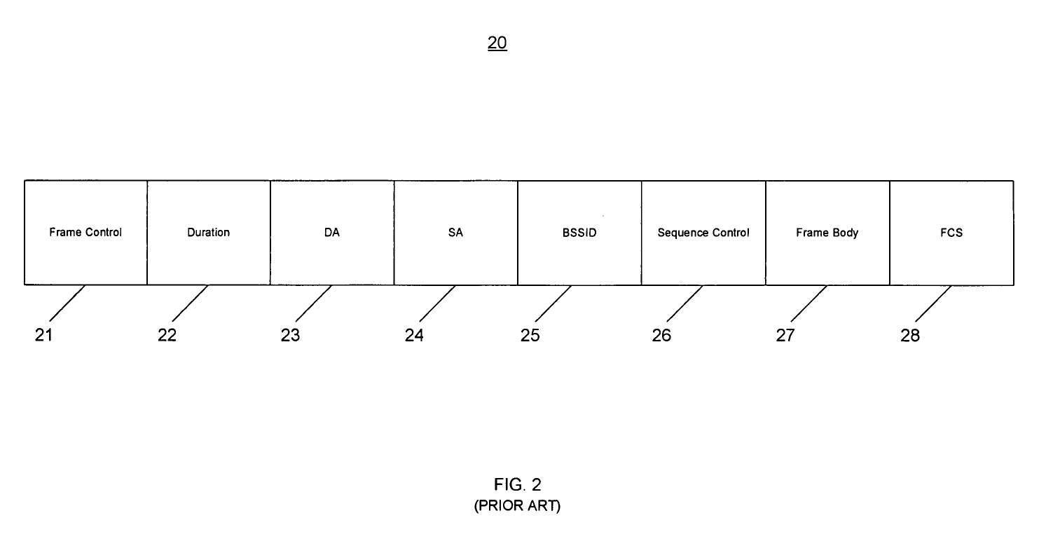

Referring to FIG. 2, a standard frame format of management packets, in accordance with the 802.11 standard, is shown. Frame 20 includes a Frame Control portion 21, which is 2 octets long. Next is a Duration 22 which is also 2 octets long, followed by a destination address (“DA”) 23 and a source address (“SA”) 24, each 6 octets long. The Basic Service Set Indicator ID (“BSSID”) 25 is next, and is 6 octets long, and the follow two octets make up the Sequence Control 27. The next piece of data is the Frame Body 28, which is the “payload” of the frame, and can range in length from 0 to 2,312 octets. The frame terminates with a Frame Check Sequence (“FCS”) 29 with a length of 4 octets.

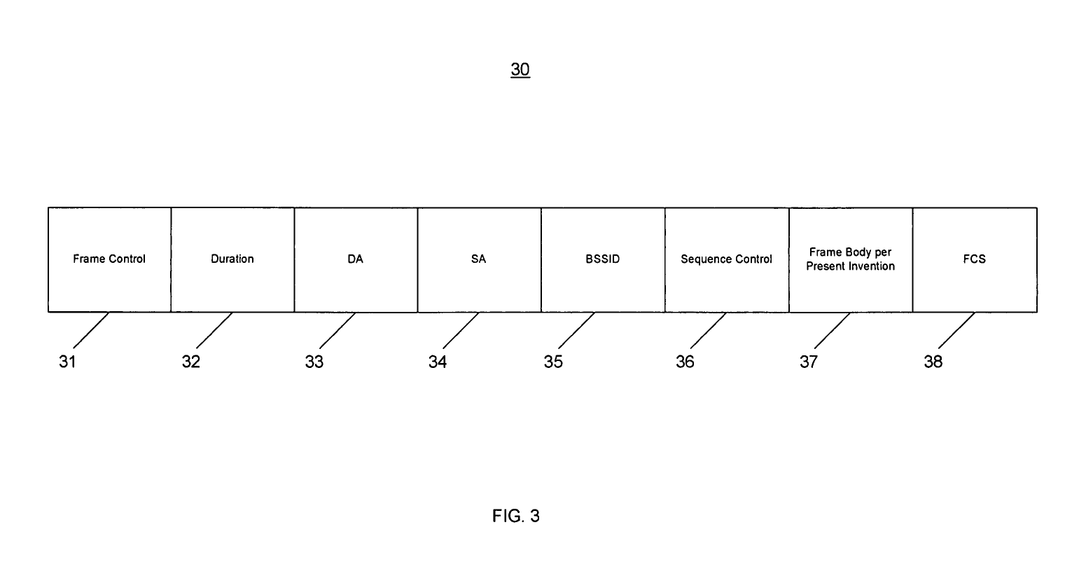

Referring now to FIG. 3, a modified frame format of management packets, in accordance with the present invention implemented in an 802.11 network, is shown. In accordance with the present invention, additional data is inserted into the Frame Body portion 37 of a management data packet to provide presence information to or from a mobile unit or network device. As shown in FIG. 3, the Frame Body segment 37 may include the standard Frame Body data 42 which would normally be transmitted in the Frame Body of 802.11 frames of the particular type, and, in accordance with the present invention, additional Presence Status data portion 44 and Presence Service Type and Parameters 46. The new data inserted into the Frame Body may be used to provide SLP, presence, and instant messaging functions natively within the framework of the network protocol.

As described above, because 802.11 Beacon, Probe Request, and Probe Response frames are transmitted regularly during normal network communications, or are transmitted when a mobile unit or device first comes into contact with a wireless network, these types of frames are ideal for purposes of the presence and instant messaging scheme of the present invention. However, other types of 802.11 frames may be used to transmit the presence and instant messaging data in accordance with the present invention.

In an exemplary embodiment of the present invention, the additional presence data 44 and 46 incorporated into the Frame Body 37 may be SLP data formatted in accordance with the scheme set forth by Guttman et al., “Service Templates and Service: Schemes,” Network Working Group RFC 2165, June 1999, (hereinafter “RFC 2165”) incorporated herein by reference in its entirety. The scheme utilizes Service URL's (“Uniform Resource Locators”) which are constructed according to the particular service scheme and which provide the information necessary to access the service. The form of such a Service URL may be as follows:
service: URL=“service:” service-type “:” site url-path
   where <service-type> may refer to a concrete protocol name or some abstract service type name, and <site url-path> may, for example, refer to a domain name, a network IP address, and/or possibly a port number. The <site url-path> data may also include an attribute list which provides information regarding attributes important for the type of service.

Referring back to FIG. 1, information regarding the presence of services such as printer 16 may be provided to mobile unit 14 in accordance with the Service URL scheme described, as follows:
service:printer:lpr://printer-hp-first-floor
   Such a string may be transmitted to the mobile unit, within the Frame Body of a management packet, to indicate that the printer 16 is connected to the network and available for use. The string may also include one or more attributes which define the capabilities of the printer or provide important interoperability information, etc. Once the service data is received by a mobile unit 12, information relating to the presence of the service may be displayed to a user on a graphical user interface, such as an icon which indicates the availability of a printer, etc.

This Service URL scheme is more fully described in RFC 2165. Importantly, the scope of the invention is not limited to the use of the scheme set forth in RFC 2165 in accordance with this exemplary embodiment.

Advantageously, data packets in accordance with the present invention may be transmitted when, for example, a user or service transitions into an active state, e.g., by touch of a mouse or keyboard which wakes the device from a “sleep mode,” by connection of a device or service to the network, by power-on of a mobile unit or association with a new access point or WLAN, etc. In such a manner, the presence services may always be updated in real-time, thus ensuring that the network clients are provided up-do-date information regarding the services available, and ensuring that the network service devices (such as printers, faxes, etc.) update the network of their availability and status as the devices become associated with the wireless network.

Moreover, the system and method of the present invention is not limited to use in providing service information to mobile units. Additionally, presence and instant messaging applications, in accordance with RFCs 2778 and 2779, may be implemented in accordance with the present invention. As described, the present invention may provide instant messaging between mobile units or between a mobile unit and another network client. Also, the presence information transmitted by a mobile unit may be used by a network administrator to, e.g., track location and operation of mobile units within the wireless network. For all of the above-described applications of this exemplary embodiment of the present invention, including instant messaging, presence, SLP, etc., data may be transmitted as described above, i.e., within the Frame Body of 802.11 management packets.

The system and method of the present invention also provide the added benefit of backward compatibility with prior art 802.11 systems. As stated in the 802.11 Specification, “[s]tations encountering an element type they do not understand ignore that element.” (IEEE 802.11 Standard for Wireless LAN Medium Access Control (MAC) and Physical Layer (PHY) Specifications, 1999 edition.) Accordingly, those networks or mobile units which are not configured in accordance with the present invention may simply ignore the relevant presence data and operate as usual.

In another exemplary embodiment of the present invention, an access point may be pre-configured with a database of services, which the access point may pass directly on to the mobile units in the above modified Probe Response or Beacon packets.

Notably, the system and method of the present invention as described herein are not limited to use in an IEEE 802.11 wireless network. One of ordinary skill in the art would understand scope of the present invention to include embodiments implemented in conjunction with other types of wireless networks (Bluetooth, GPRS, WWAN, etc.) as well as conventional wired networks.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. A method for providing presence services in a computer network operating according to a network protocol, comprising the steps of:
generating a first data packet in a format in accordance with said network protocol;
generating a second data packet by inserting presence data into said first data packet, said presence data including at least information relating to one or more services available over said computer network, and
transmitting said second data packet over said computer network.

2. The method of claim 1, wherein said network protocol is a wireless network protocol.

3. The method of claim 1, wherein said presence data includes at least one Service URL.

4. The method of claim 2, wherein said wireless network protocol is an IEEE 802.11 wireless network protocol.

5. The method of claim 2, wherein said wireless network protocol is a Bluetooth wireless network protocol.

6. The method of claim 2, wherein said wireless network protocol is a GPRS wireless network protocol.

7. A method for providing instant messaging services in a network protocol, comprising the steps of:
generating a first data packet in accordance with the network protocol;
generating a second data packet by inserting instant messaging data into said first data packet, said instant messaging data including at least text message data, and
transmitting said second data packet over said computer network.

8. The method of claim 7, wherein said network protocol is a wireless network protocol.

9. The method of claim 8, wherein said wireless network protocol is an IEEE 802.11 wireless network protocol.

10. The method of claim 8, wherein said wireless network protocol is a Bluetooth wireless network protocol.

11. The method of claim 8, wherein said wireless network protocol is a GPRS wireless network protocol.

12. A system for providing Instant Messaging Presence Protocol (“IMPP”) over a computer network, comprising:
a computer-readable memory, and
a processor coupled to said memory and operable to generate a data packet formatted for transmission in accordance with a network protocol,
wherein said processor is further operable to include IMPP data in said data packet before said data packet is transmitted over a computer network.

13. The system of claim 12 wherein said computer network comprises a wireless portion.

14. A system for providing modified network protocol communications over a computer network, comprising:
a computer-readable memory, and
a processor coupled to said memory and operable to generate a data packet formatted for transmission in accordance with a network protocol,
wherein said processor is further operable to include presence data in said data packet before said data packet is transmitted over a computer network, said presence data relating to services or devices available on the computer network.

15. The system of claim 14 wherein said computer network comprises a wireless portion.

16. A system for providing presence services in a computer network, comprising:
a first computing device communicatively coupled to a computer network and configured to communicate over said computer network in accordance with a network protocol;
a second computing device communicatively coupled to said computer network and configured to communicate over said computer network in accordance with said network protocol;
wherein presence data about said first computing device is provided to said second computing device natively as part of ordinary communications in accordance with said network protocol.

17. The system of claim 16 wherein said computer network comprises a wireless portion.
